(19) United States
(12) Patent Application Publication
(10) Pub. No.: US 2001/0040840 A1
(43) Pub. Date: Nov. 15, 2001

(54) Wristwatch case having a rotary vessel

(76) Inventors: Dai Terasawa, Chiba-shi (JP); Toshiaki Kume, Chiba-shi (JP); Masayuki Kimura, Chiba-shi (JP)

Correspondence Address: ADAMS & WILKS, 31st Floor, 50 Broadway, New York, NY, 10004, US

(21) Appl. No.: 09/819,478

(22) Filed: Mar. 28, 2001

(30) Foreign Application Priority Data
Mar. 30, 2000 (JP) 2000-093518

(51) Int. Cl. G04B 37/00; G04B 39/00

(52) U.S. Cl. 368/295

(57) ABSTRACT

The rotary vessel is structured having a function movable generally vertical relative to a plane of a wristwatch case, and divided with a plurality of stop points in a movable range in a vertical direction, i.e. a stop point for securing stop stability of rotation and a stop point for rotating the rotary vessel. Due to this, in the case that the rotary vessel is in a rotatable state, rotation torque can be minimized.

### BACKGROUND OF THE INVENTION

1. Field of the Invention

The present invention relates to a wristwatch case having a rotary vessel.

2. Description of the prior Art

It has been possible for the wristwatch case attached with a conventional rotary vessel to rotate the rotary vessel. However, the rotary vessel could not have been moved in a vertical direction.

The wristwatch case attached with a conventional vessel has following problems.

(1): Despite having a function to rotate the rotary vessel, vessel rotation torque had to be heavy in order to secure stability in a stop state of the rotary vessel.

(2): Because of (1), large concave-convex form must have been structured on a surface of the rotary vessel.

(3): When operating the rotary vessel by the finger, a pain is felt in the finger.

In the present invention, it is a problem to provide a wristwatch case attached with a rotary vessel which solves the foregoing problem and is easy to rotate without the necessity of heavy rotation torque and concave-convex form on the rotary vessel surface while securing stability in a stop state of the rotary vessel.

### SUMMARY OF THE INVENTION

The rotary vessel is structured having a function movable generally vertical relative to a plane of a wristwatch case, and divided with a plurality of stop points in a movable range in a vertical direction, i.e. a stop point for securing stop stability of rotation and a stop point for rotating the rotary vessel. Due to this, in the case that the rotary vessel is in a rotatable state, rotation torque can be minimized.

According to the present invention, in a stop point for securing stop stability of rotation, the gear-formed concave-convex provided on the rotary vessel engages the rotation regulating portion of a concave-convex-formed gear of the rotation regulating ring. In a stop point for rotation, engagement is released from the rotation regulating portion of the rotation regulating ring, minimizing rotation torque.

### BRIEF DESCRIPTION OF THE DRAWINGS

A preferred form of the present invention is illustrated in the accompanying drawings in which:

FIG. 1 is a principal-structure fragmentary sectional view of a rotary-vessel lower stop point of the present invention;

FIG. 2 is a principal-structure fragmentary sectional view of a rotary-vessel upper stop point of the invention;

FIG. 3 is a principal-structure fragmentary sectional view of the rotary-vessel lower stop point of the invention;

FIG. 4 is an A-A arrow direction fragmentary sectional view in a rotary-vessel lower stop point of the invention;

FIG. 5 is a principal-structure fragmentary sectional view of a rotary-vessel upper stop point of the invention;

FIG. 6 is a B-B arrow direction fragmentary sectional view in a rotary-vessel upper stop point of the invention;

FIG. 7 is a plan view of a ring elastic member part of the invention; and

FIG. 8 is a principal-structure fragmentary sectional view of a conventional rotary vessel.

### DETAILED DESCRIPTION OF THE PREFERRED EMBODIMENTS

An embodiment of the present invention will be explained below with reference to the drawings.

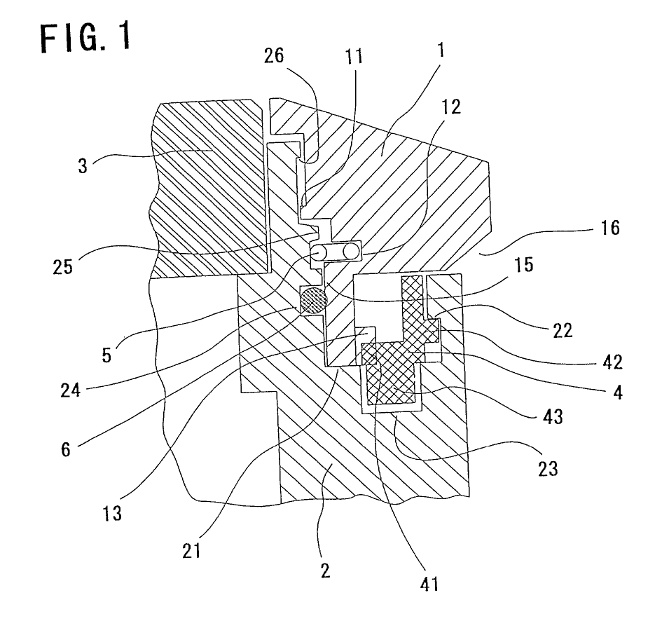

The present invention is structured, as shown in FIG. 1, by a degree-contact step 11, a positioning groove 12 holding a positioning elastic member 5, a rotary vessel 1 having a gear-formed concave-convex portion 13 arbitrary divided relative to a planar form, a vessel degree-contact surface 26, a case barrel 2 having a positioning protrusion 25, a rotation-stop dowel 43 engaged in a rotation-stop hole 23, and a rotation regulating ring 4 having a rotation regulating portion 41 corresponding to the gear-formed concave-convex portion 13 and fixed on the case barrel 2. A glass 3 is attached to the case barrel 2.

FIG. 1 shows a state that a rotary-vessel bottom surface 14 is in contact with a rotary-vessel receiving surface 21 of the case barrel 2, the state of which is defined as a lower stop point. The rotary vessel 1 can stop at the lower stop point by the positioning elastic member 5 held by the positioning groove 12 of the rotary vessel 1 and the positioning protrusion 25 of the case barrel 2.

The rotation regulating ring 4 does not rotate due to the engagement of the rotation stop dowel 43 possessed by the rotation regulating ring 4 with rotation stop hole 23 in singular or plurality opened in the case barrel 2. At this time, engagement is made between the gear-formed concave-convex portion 13 of the rotary vessel 1 and the rotation regulating portion 41 of the rotation regulating ring 4 fixed on the case barrel 2, whereby the rotation vessel 1 is secured with stop stability and not rotated.

The rotation regulating portion 41 of the rotation regulating ring 4 fixed on the case barrel 2 is provided singular or in plurality.

By the contact of the chatter preventing elastic member 6 fitted in the fixing groove 24 of the case barrel 2 with the elastic contact surface 15 of the rotary vessel 1, the rotary vessel 1 is further secured with stop stability.

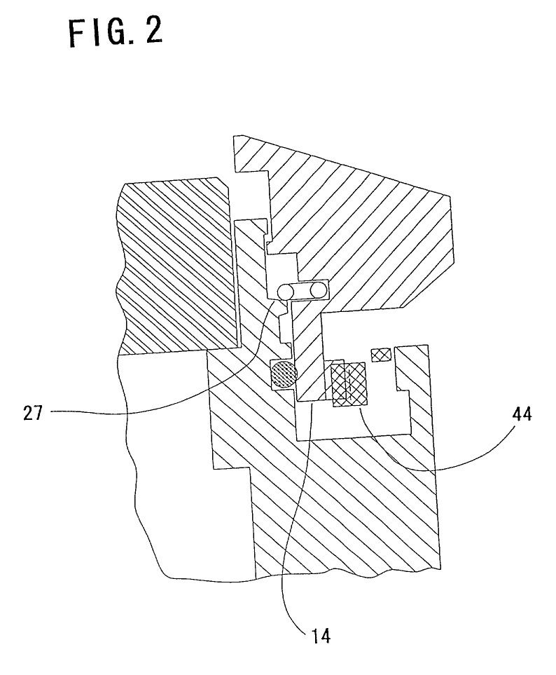

FIG. 2 shows a state that, by putting the finger on the finger-putting slant surface 16 to vertically move the rotary vessel 1, the positioning elastic member 5 held by the positioning groove 12 of the rotary vessel 1 is deflected and gotten over the positioning protrusion 25 of the case barrel 2. At this time, the positioning elastic member 5 held by the positioning groove 12 of the rotary vessel 1 interferes with a protrusion upper surface 27 of the case barrel 2, whereby the rotary vessel 1 is allowed to stop at the upper stop point. Thus, the rotary vessel 1 is allowed to rotate stably in the upper stop point.

In this state, the engagement between the gear-formed concave-convex portion 13 of the rotary vessel 1 and the rotation regulating portion 41 of the rotation regulating ring 4 fixed on the case barrel 2 is completely released to allow the rotary vessel 1 to rotate freely.

In order to prevent the rotation regulating ring 4 fixed on the case barrel 2 from moving together with the rotary vessel 1 to the upper stop point when the rotary vessel 1 is moved to the upper stop point, the rotation regulating ring 4 has a removal preventing protrusion 42. Due to the interference between the removal preventing protrusion 42 of the rotation regulating ring 4 and a circumferential groove upper wall 22 of the case barrel 2, the rotation regulating ring 4 does not move to the upper stop point.

In the upper stop point, meshing is made between the gear concave portion 17 of the gear-formed concave-convex portion 13 of the rotary vessel 1 and a click elastic protrusion 45 provided in a click elastic portion 44 of the rotation regulating ring 4 fixed on the case barrel 2.

When the rotary vessel 1 is rotated, the click elastic protrusion 45 provided in the click elastic portion 44 of the rotation regulating ring 4 radially moves due to a rotation force and intermittently interferes with the gear-formed concave-convex portion 13, providing a click feel to the rotary vessel 1.

The rotation regulating portion 41 of the rotation regulating ring 4 and the click elastic protrusion 45 are alternately arranged with respect to a plane.

Also, the rotation regulating portion 41 of the rotation regulating ring 4 and the click elastic protrusion 45 are arranged in upper and lower surfaces with respect to a direction of the plane.

The click elastic portion 44 of the rotation regulating ring 4 and the click elastic protrusion 45 are provided in a single or a plurality of positions.

In order to prevent the rotary vessel 1 from disengaging from the case barrel 2 upon moving the rotary vessel 1 in the upper direction, the rotary vessel 1 has a degree-contact step 11 and the case barrel 2 has a vessel degree-contact portion 26.

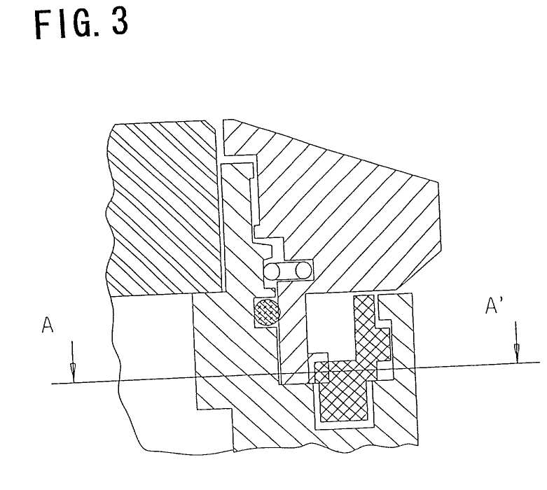

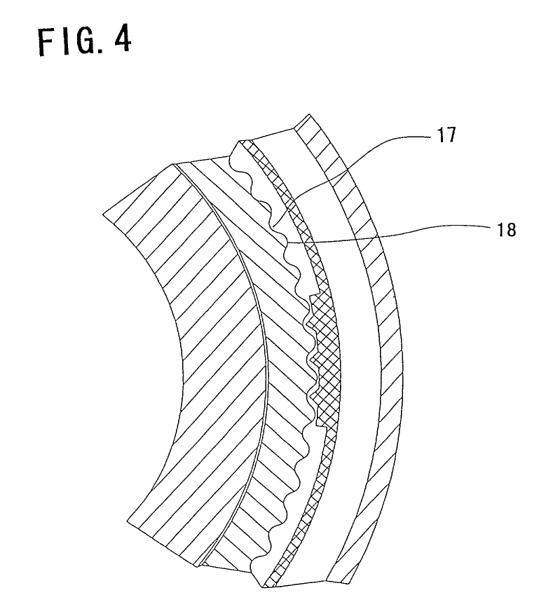

FIG. 3 shows the rotary vessel 1 in the lower stop point, and FIG. 4 is a sectional view along line A-A in FIG. 3. The gear-formed concave-convex portion 13 having the gear concave portion 17 and the gear convex portion 18 engages the rotation-regulating portion 41 of the rotation regulating ring 4 on a plane, so the rotary vessel 1 does not rotate.

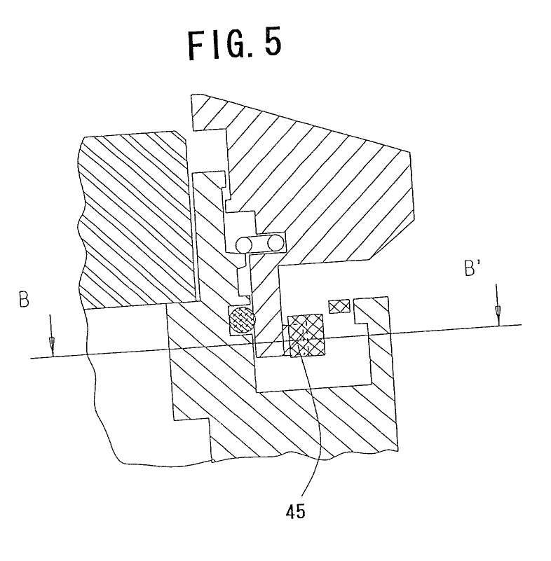

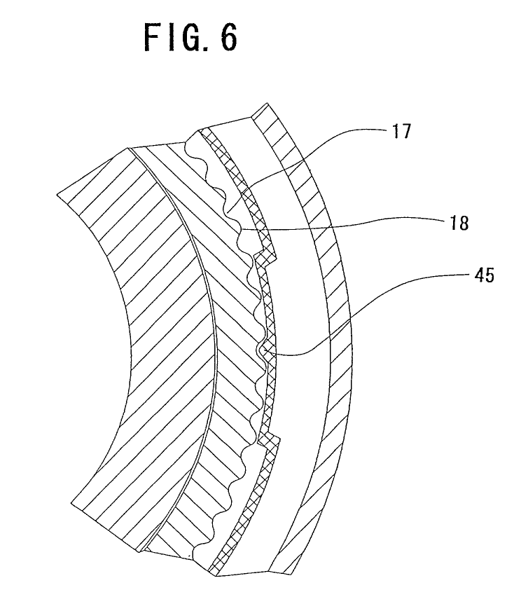

FIG. 5 shows the rotary vessel 1 in the upper stop point, and FIG. 6 is a sectional view along line B-B in FIG. 5.

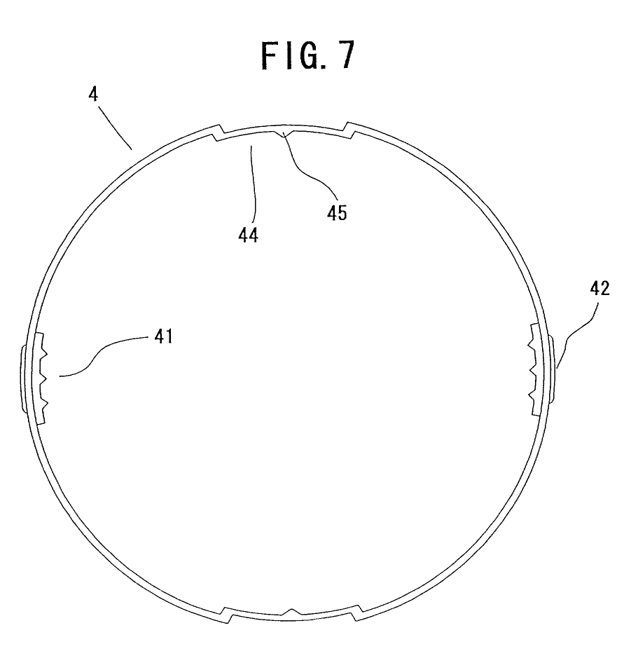

FIG. 7 shows a plan view of the rotation regulating ring 4. FIG. 7 shows a state in which the rotation-regulating portion 41 and the click elastic protrusion 45 are alternately arranged on a plane.

In this invention, as described above, a rotary vessel structure for a wristwatch case having a rotation function of the rotary vessel 1 different depending on a stop position was realized, wherein, when the rotary vessel 1 is positioned in the lower stop point, the gear-formed concave-convex portion 13 engages the rotation regulating portion 41 of the rotation regulating ring 4 to prohibit the rotary vessel 1 from rotating, while, when the rotary vessel 1 is positioned in the upper stop point, the meshing is released between the gear-formed concave-convex portion 13 and the rotation regulating portion 41 of the rotation regulating ring 4 to allow the rotary vessel 1 to rotate freely.

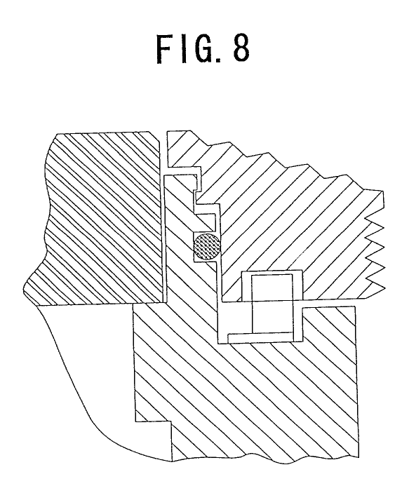

As a result of this, stop stability and rotation operationality are both provided in the conventional rotary vessel structure having no vertical change of position. As a result, contrary to the current situation that the rotary vessel requires heavy rotation torque and concave-convex form is unavoidably required on a surface or peripheral portion of the rotary vessel to obtain sufficient rotation torque upon rotating the rotary vessel by the finger, as shown in FIG. 8, a wristwatch case having a rotary vessel was realized assuring stop stability and rotation ability without the necessity of providing a concave-convex form on a surface or peripheral portion of the rotary vessel. Also, because the rotation torque can be minimized, no pain is felt in the finger during actuating rotation. Also, the design restriction of the rotary vessel requiring a concave-convex form is eliminated thus providing a great effect of increasing design freedom.

As shown in FIG. 5, it is possible to provide a click feel to free rotation of the rotary vessel 1 by causing slight interference due to the gear-formed concave-convex portion 13 and the click elastic protrusion 45 provided in the click elastic portion 44 in a state that the rotary vessel 1 is positioned in the upper stop point.

What is claimed is:

1. A wristwatch case having a rotary vessel comprising:
a rotary vessel having a structure movable generally vertical with respect to a plane of a wristwatch case; and
a rotation regulating ring having a rotation mechanism on a circumference different in rotation function of the rotation vessel at a plurality of stop points in a vertical movable range;
wherein the rotation regulating ring is arranged between a rotary vessel and a case barrel.

2. A wristwatch case having a rotary vessel comprising:
a rotary vessel having a structure movable generally vertical with respect to a plane of a wristwatch case; and
a positioning elastic member to stop the rotary vessel in each of a plurality of positions.

3. A wristwatch case having a rotary vessel according to claim 1, wherein the rotation regulating ring is arbitrary divided the circumference of the rotation regulating ring and planarly alternately arranged a plurality of rotation mechanisms different in vessel rotation function.

4. A wristwatch case having a rotary vessel according to claim 3, wherein the rotation regulating ring is planarly alternately arranged the plurality of rotation mechanisms different in vessel rotation function.

5. A wristwatch case having a rotary vessel according to claim 1, further comprising:
a gear-formed concave-convex portion formed in the rotation vessel; and
a click elastic protrusion to interfere with the gear-formed concave-convex portion, to radially move due to a rotation force on the gear-formed concave-convex portion to cause a click feel and to arrange the rotation regulating ring;
wherein the click elastic protrusion causes a click feel by intermittently interfering with the gear-formed concave-convex portion.

6. A wristwatch case having a rotary vessel according to claim 5, wherein the gear-formed concave-convex portion of the rotary vessel is formed to a planar form of the rotary vessel.
